(19) United States
(12) Patent Application Publication
(10) Pub. No.: US 2018/0227256 A1
(43) Pub. Date: Aug. 9, 2018

(54) System, Method, and Apparatus for Electronic Messaging

(71) Applicant: Len Wilson, West Hollywood, CA (US)

(72) Inventor: Len Wilson, West Hollywood, CA (US)

(21) Appl. No.: 15/429,123

(22) Filed: Feb. 9, 2017

(51) Int. Cl. H04L 12/58; G06T 13/80; G11B 27/031; G11B 27/00

(52) U.S. Cl. CPC H04L 51/10; H04L 51/04; G11B 27/005; G11B 27/031; G06T 13/80

(57) ABSTRACT

An electronic messaging system, method, and apparatus are provided. In particular, the system and method enables composing, sending, and receiving compiled video messages by presenting a variety of selections that may be chosen, arranged in a sequence, and compiled into a compiled electronic video message, which may be sent to and received by one or more recipients via a network. The compiled video message may provide for playback of one or more animated selections, so as to create an expression capable of being comprehended by a recipient. To increase expression possibilities, the present invention may provide for one or more recipients the capability to edit the compiled video message, compile an edited compiled video message, and send the edited compiled electronic video message to one or more additional recipients.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to electronic messaging social media communication, and, more particularly, to a system, method, and apparatus for combining one or more emojis, animations, videos, GIFs (Graphics Interchange Format), text selections, audio files, apngs, image sequences, or other communication forms into a compiled video message wherein the compiled video message comprises one or more animations played in a sequence. It is contemplated that the compiled video message, the process of creating the compiled video message, and the process of viewing the compiled video message may each enable a user to form and express feelings, thoughts, ideas, and other expressions.

### BACKGROUND

A variety of electronic messaging platforms exist on the market, including those designed to work on desktop computers, mobile phones, or tablets. Some electronic messaging platforms currently in existence employ, in part, embedded emojis or videos and may to some extent allow the user to customize their use so as to personalize a message. For instance, in iMessage, well known in the art, one or more emojis can be selected from a keyboard, inserted into a message, and the message can be delivered with a video overlay such as confetti falling around the message. Another example is the dating application Bumble, also well known in the art, which also allows users to select a GIF from a selected list and then send the GIF as an electronic message.

Some other attempts to further personalize electronic messaging have been made. Examples include, for instance, U.S. Pat. No. 6,304,898B1 to Shiigi, which generally discloses an electronic messaging system that allows users to generate, capture, and send handwritten messages in their electronic messages. While indeed allowing for personalized expressions, this disclosure fails to provide for the sequential use of images or videos that, taken together, present a unified thought or emotion.

Another example is U.S. Patent Application Publication No. US2007/0244977A1 filed by Atkins, which generally discloses an email messaging system capable of embedding videos and hyperlinks in non-traditional message fields, such as the signature line, and in a non-traditional sequence, such as after the message is sent. Although this disclosure does provide for unique sentiment constructions and delivery systems, it fails to address these needs beyond the email format, and lacks a truly integrated embedding feature.

Another example can be found in U.S. Patent Application Publication No. 2015/0255057 A1 filed by Levy, which generally discloses a messaging platform that “maps” pre-recorded audio to text or emoji input. While this disclosure does generally provide the user with an expanded bank of available sentiments, and does allow the user to arrange them in a sequential order to create a coherent thought, this disclosure does not provide for an equivalent image, video, or GIF element.

Still, none of these in existence comprise the beneficial characteristics described in the following disclosure. Thus, there remains a need for an electronic messaging system, method, and apparatus that enables a user to send a compiled video message that may play one or more selections in sequence, the cumulative effect of which may be to communicate a more complex expression to a recipient than something that does not play in a sequence.

### SUMMARY

The present disclosure is directed to a system, method and apparatus that, in some embodiments, allows a user to generate new and creative expressions of complex thoughts, feelings, ideas, or stories (“expressions”) using a mix of emoji characters and animations, numeric characters and animations, letters and letter animations, symbols and symbol animations, characters and character animations, videos, GIFs, apngs, image sequences, or other communication elements (“selections”) that may appear to move (“animate”). Once one or more selections are chosen and arranged within a preview port in a messaging application, the present invention may then compile the selections into a coherent whole, such as by way of illustration and not of limitation, into a new compiled video message. Once activated, the compiled video message may play the selections in a playback sequence, wherein each selection may animate at a predetermined timing mark of playback and may play an audio file, thereby communicating an expression to a recipient.

The present invention may assign each selection its own unique set of variables that determine when and how each selection may perform playback. Such examples of variables may include, by way of illustration and not of limitation, where in the selection's timecode the selection may begin playback, if the selection should pause its playback, if the selection should continue its playback from a paused state, if the selection should rewind or loop playback, or if the selection should initiate another function, such as for example, opening a link or playing an audio file.

It is contemplated that one selection's variables may also have similar effects on other selections' variables in a sequence as well. For example, one selection's variables may impact another selection's sequence of playback, when another selection begins playback, when and if a selection's playback should loop, timing for a selection's action(s) based on what the selection may be, where the selection may be placed within the sequence, what the other selections in a sequence may be, and where the other selection may be placed in a sequence if one or more selections in the sequence should temporarily pause, restart, stop, or initiate another function such as opening a link or playing an audio file.

It is contemplated that in one or more embodiment, the user may override one, more than one, or all variables, enabling the user to directly assign timing for one or more selections.

Furthermore, multiple versions of each selection in the selection bank may exist. In certain embodiments, it is contemplated that such alternate versions of selections may only be available or known to a user after the user has selected the selection from the selection bank. In such a scenario, it is contemplated that an alternate version(s) of one or more selections may then be visible in the preview port where the user may arrange the selection in a sequence, whereupon the present invention may then generate a compiled video message based on the content visible in the preview port.

By way of illustration and not of limitation, the present invention may provide for two or more versions of a selection, such as for example a spinning slice of pizza, each version having a different start time, a different pause time, a different length, a different animation and playback speed, or a different set of additional functions or types of audio playback. However, these additional versions, in some embodiments, may only be represented by one selection icon in the selection bank. Because the present invention may automatically select which version or versions of a selection might best appear in a sequence or in a compiled video message based on the set of variable assigned to the selection, the present invention may or may not display every variation of the selection in the selection bank, the preview port, or even, in some embodiments, a compiled video message. In such an embodiment, by automatically selecting the version or versions of a selection, the present invention may alleviate the user of the necessity of choosing between multiple versions of a selection from the selection bank. It is contemplated that such a functionality may help to simplify the users experience when the user is trying to create a complex thought via the present invention.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In one embodiment, the present invention may provide for a user to choose selections that may all become part of a compiled video message that may be sent via an electronic messaging system or a social media platform to a recipient, whereupon the compiled video message may display a sequential playback of the selections for the recipient. By way of example and not of limitation, the present invention may provide a user with a selection bank, wherein the user may perceive a variety of selections. Then, the user may choose selections from within the selection bank, which for purposes of illustration and not limitation may include a bouncing “I” animation selection, a pulsing heart animation selection, and a spinning slice of pizza animation selection. The user may then arrange the selections horizontally within a preview port in a preferred order, and initiate a compilation function wherein the present invention may compile the selections into a compiled video message. The present invention or the user may assign one or more playback delay codes to one or more selections at any point during the selection, sequencing, arranging, or compiling of one or more selections. Then, the user via the present invention may send the compiled video message to a recipient via an electronic messaging system or a social media platform. When the recipient views the compiled video message, the compiled video message may play each of the selections sequentially based on a predetermined timing sequence created by the present invention or sender of the message. Again, for purposes of illustration and not of limitation, the present invention could begin to animate a bouncing “I” animation selection at the 00:00 timing mark of playback, a pulsing heart animation selection at the 00:01 timing mark of playback, and a spinning slice of pizza animation selection at the 00:02 timing mark of playback. After a predetermined amount of time, the present invention may cease playback of one or more selections, or it may loop its playback and start animating from the 00:00 timing mark again. It is contemplated that, after viewing the compiled video message, a recipient could infer the expression “I love pizza.”

In another embodiment, a user may assign a delayed start time to one or more selections independent of the selection's arrangement within the preview port or the compiled video message. By way of illustration and not of limitation, using the example discussed above, a user could assign the heart selection a delayed playback start time of 00:00 timing mark of playback, the “I” a delayed start time of 00:01 timing mark of playback, and the slice of pizza a delayed start time of 00:02 timing mark of playback. In this illustrative example, although arranged in a left-to-right order of “I”, heart, and slice of pizza, the playback sequence may provide for the heart to begin its animation first, followed by the “I”, and followed by the pizza.

In another embodiment, the present invention may provide for a first user who may include one selection in an electronic message that may be sent to a second user, whereupon the second user, via the present invention, may add, delete, rearrange, or otherwise modify the electronic message by adding one or more selections and then compiling the electronic message, thereby creating a compiled video message. The second user may then send the compiled video message to the first user, or to one or more additional users.

In some embodiments, the present invention may provide for a first user who may send a compiled video message to a second user, whereupon the second user, via the present invention, may add, delete, rearrange, or otherwise modify the compiled video message. The second user may then send the modified compiled video message to one or more recipients, who may be the first user or one or more additional users. The present invention may allow one or more recipients to also modify the modified compiled video message into a second modified compiled video message, and send the second modified compiled video message to further additional users. It is contemplated that the number of users who may participate in a sequence of editing and sending compiled video messages between one or more users may only be limited by the capacities of a network, a device, user behavior, or the present invention. It is further contemplated that the present invention may support the sending and receiving of compiled video messages having any combination of modified or unmodified elements within the compiled video message.

In another embodiment, the present invention may provide for one or more selections to be arranged within a preview port and compiled into a compiled video message wherein only one selection appears during playback at a time. To use the foregoing example, again for purposes of illustration and not of limitation, a user could choose an I, a heart, and a slice of pizza selection, arrange them in any manner described herein within a preview port, and compile the selections into a compilation video message. When a recipient views the compilation video message, however, the “I” selection may begin playback, then may be replaced by the heart and its playback, which in turn may be replaced by the slice of pizza and its playback. It is contemplated that such an embodiment would also be capable of repeated playback, various arrangements, and other such features as described herein.

In another embodiment, one or more selections may be assigned additional functionality, such as for example and not limitation, an animation might initiate a second, third, or more functionality. Illustrative examples could include a sound, an internet link “click,” or other “event.” To use the illustration of the “I”, the heart, and the slice of pizza as discussed above, such functionality could include a functionality wherein when the slice of pizza begins playback, it opens a link to a pizza delivery business' website. Another example could include a functionality wherein, when the heart begins playback, it is accompanied by a heartbeat sound. It is contemplated that any event within an electronic device's capabilities could be linked to any functionality selection.

In another embodiment, the present invention may provide for a functionality wherein a user may choose one or more selections within the compiled video message to replay again individually.

In another embodiment, the compiled video message may begin playback when clicked-on by a recipient. In some embodiments, the compiled video message may initiate auto playback when viewed via a text application or a social media application.

In another embodiment, when the compiled video message has finished playback, the compiled video message may play from the 00:00 timing mark of playback again, thereby creating a loop.

In another embodiment, when the compiled video message has finished playback, the compiled video message may wait for a different action, such as shaking or re-orienting a mobile device from upright to planar, from the recipient in order to repeat playback.

It is contemplated that the present invention may provide for a user to incorporate less than three, or more than three, selections into a compiled video message.

It is also contemplated that the present invention may provide for a user to import one or more selections into the present invention, such as by way of illustration and not of limitation, from a user's camera, computer, or other electronic device.

In still another embodiment, one or more selections may appear in a vertical, diagonal, circular, or other visual or spatial arrangement within the preview port or the compiled video message.

Thus it is an object of the present invention to provide a superior communication medium, whereby for example and not by way of limitation, a delayed start time for each animation inside a compiled video message may better communicate an expression than would a simultaneous playback of all the selections. It is contemplated that a delayed timing may prompt a user to contemplate a compiled video message, which in turn may facilitate better comprehension of the sender's intended message.

Another object of the present invention is to stimulate a user to discover one or more new expressions while using the present invention, and to enable a user to communicate the same to a recipient.

It is contemplated that selections may comprise any letter, number, image, video, apng, sound file, GIF, or other file type whether made available by the present invention, the user, an internet database, or other source of data suitable for use in the present invention, including selections generated by a user using the present invention or imported by a user into the present invention.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a block diagram of a networked environment in which an exemplary embodiment of a system for electronic messaging is implemented.

FIG. 2 is a flowchart depicting an exemplary embodiment of a method for electronic messaging which may be implemented by the system shown in FIG. 1.

FIG. 3 illustrates an exemplary embodiment of a mobile device shown in FIG. 1.

FIG. 4 illustrates an exemplary user interface for a system and method for electronic messaging.

FIG. 5 illustrates a playback sequence of a compiled video message in accordance with one embodiment of the present invention.

FIG. 6A-H illustrates a plurality of exemplary user interfaces for a system and method for electronic messaging.

FIG. 7 is a block diagram illustrating an exemplary embodiment of a method for electronic messaging.

FIG. 8 illustrates a playback sequence of a compiled video message in accordance with one embodiment of the present invention.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

Because the present invention is contemplated, in certain embodiments, to provide for a series of moving images to be contained within a single message, which when activated, viewed, played, or displayed may provide for the images to begin or cease moving at predetermined timing marks of a playback sequence, the terms “animate” and “playback,” and the like should also be broadly understood to refer to the present invention's capacity to make images move, and to do so within a playback sequence. In certain embodiments, the term “animate,” for example, may refer to an image moving. “Playback” may refer to one or more “animations” initiated in a sequence.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

It is to be understood that the term compiled video message, as described or depicted herein, is meant to encompass all forms of a compiled video message however created, whether by one user, two users, or more than two users. The arrangements of compiled video messages as depicted or described herein are also intended, unless otherwise noted, other alternate arrangements including horizontal, vertical, diagonal, in separate columns, in separate rows, and so forth. Compiled video messages may contain one or more selections. It is contemplated that the selections may comprise emoji characters and animations, numeric characters and animations, letters and letter animations, symbols and symbol animations, characters and character animations, videos, GIFs, apngs, image sequences, or other communication elements. Further, it is contemplated that the compiled video messages themselves may comprise one or more emoji characters and animations, numeric characters and animations, letters and letter animations, symbols and symbol animations, characters and character animations, videos, GIFs, apngs, image sequences, or other communication elements.

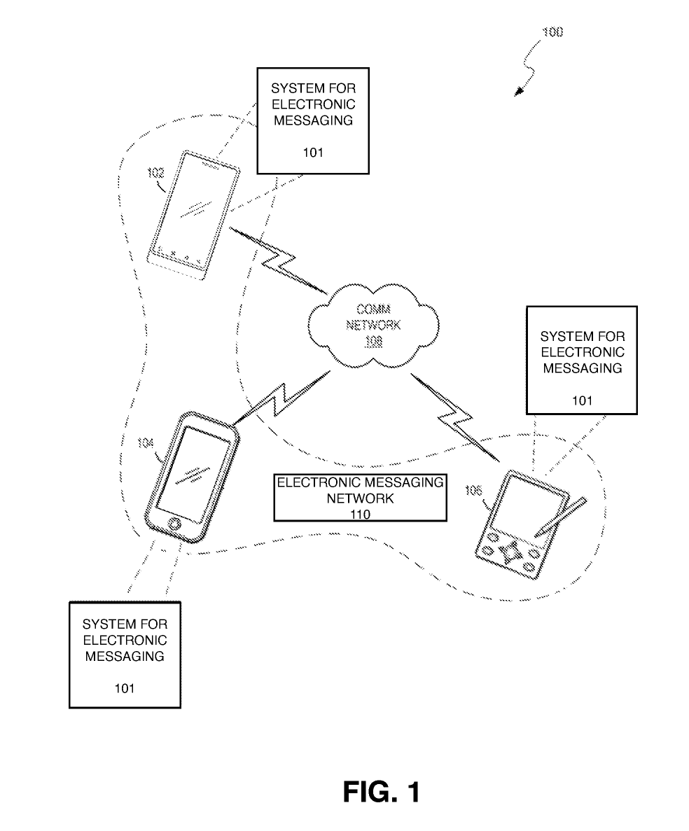

FIG. 1 illustrates an exemplary embodiment of the system 100 which includes a plurality of mobile devices communicatively coupled to one another. By way of example, and not limitation, FIG. 1 illustrates three mobile devices 102, 104, and 106 that incorporate a system for electronic messaging 101 and are communicatively coupled via a communication network 108. Each of the mobile devices may be embodied as a mobile computing device such as, for example and without limitation, a smartphone or tablet computer that incorporates cellular telephone functionality. Notably, the communications network can use one or more of various communications types such as, for example and without limitation, cellular and Wi-Fi communications.

Users of mobile devices 102, 104, and 106 may be users of an electronic messaging network 110 comprised of at least one existing network known to those skilled in the art. For instance, as noted above, the users of mobile devices 102, 104, and 106 may be communicatively linked via any one or a combination of FACEBOOK®, TWITTER®, LINKEDIN®, INSTAGRAM®, iMESSAGE®, GOOGLE HANGOUT®, SNAPCHAT®, an email network, or any messaging system that utilizes the internet or wireless communications. Such a messaging network 110 enables anyone, then, to use their devices 102, 104, and 106 to send electronic messages to each other. In this case, the system 100 utilizes an existing network to enable a user to send an electronic message containing a compiled video message as described herein to one or more recipients.

Returning to FIG. 1, an electronic messaging network 110 may be facilitated by a website that may require a registration and login prior to use. However, regardless of how such an electronic messaging network is implemented, the functionality of concern involves the ability to provide a coherent thought or sentiment via a compiled video message containing one or more selections that may be played in sequence, the total effect of which is intended to create an impression upon the recipient. In an embodiment, the electronic messaging network 110 may be made available to any user of any compatible network. In another embodiment, however, it is contemplated that the electronic messaging network 110 may be accessible to only limited members who subscribe. Still, it is contemplated that anyone may receive a compiled video message.

In one embodiment, a first user may use their device 102 to access the present invention, choose one or more selections, arrange one or more of the selections in a sequence, the whole of which may constitute a compiled video message, and send the compiled video message via a network to a first recipient on their device 104 and possibly a second recipient on their device 106 as well. It is contemplated that the present invention may provide for a large number of recipients, similar to a “group text” as that term is known in the art.

In another embodiment, by way of illustration and not limitation, a first participant may prepare a first version of a compiled video message on their device 102 and send the compiled video message to a second participant on their device 104. The second participant may then modify the compiled video message on their device 104, and send the modified compiled video message to a third participant on their device 106. By way of non-limiting example, the first participant could create a compiled video message on their device 102 which could consist of an animated “I” followed by an animated heart, and a second participant, after receiving the compiled video message on their device 104, could add an animated pizza to the compiled video message and send it to a third participant's device 106. It is contemplated that, in an alternative embodiment, a series of modifications to a compiled video message could occur with more than three participants.

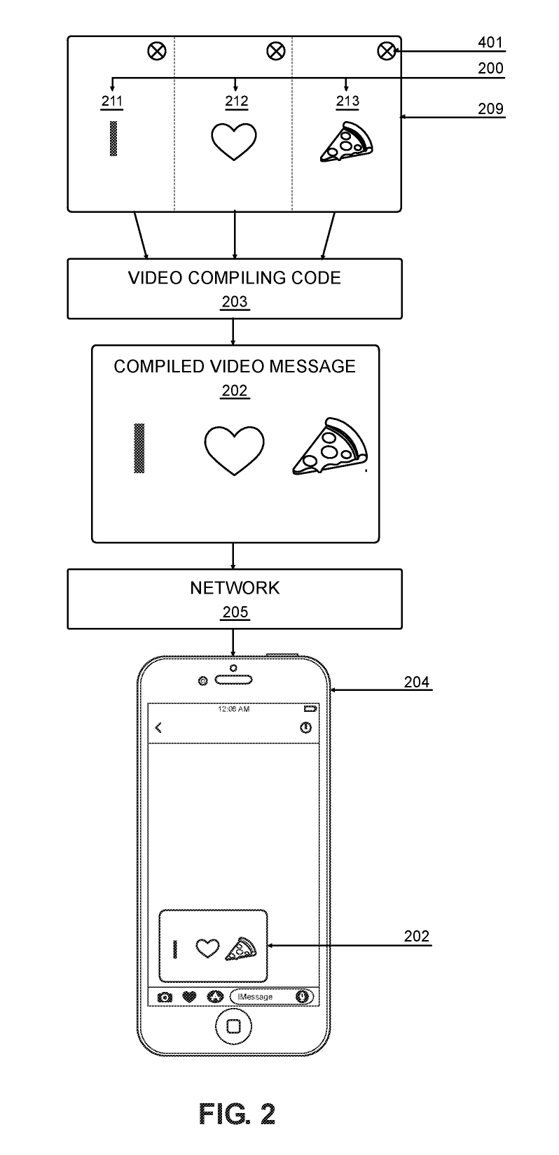

FIG. 2 is a flowchart depicting one of many potential embodiments of a system and method for electronic messaging that may be performed by mobile device 102, 104, or 106 of FIG. 1. The method shown in FIG. 2, includes the steps of: choosing three selections 200 and arranging the selections 200 within the preview port 209; implementing a video compiling code 203 so as to compile and or render selections 200 into a compiled video message 202; sending the compiled video message 202 to one or more recipient's electronic device 204, which may be a device similar to 102, 104, 106, or any electronic device capable of implementing the present invention, via a network 205 receiving the compiled video message 202; and, viewing playback of the compiled video message 202 via the recipient's electronic device 204. For purposes of illustration and not of limitation, hypothetical examples of selections 200 have been depicted including an animation of a bouncing “I” 211, an animation of a pulsing heart 212, and a spinning slice of pizza 213.

Various methods for electronic messaging are contemplated. For example, in FIG. 2, the number of selections 200 could be fewer or greater than three. Alternatively, one or more selections 200 might not animate. Alternatively, it is also contemplated that in certain embodiments selections 200 could animate for a specified duration. Alternatively, it is also contemplated that selections 200 could start and stop animating repeatedly. In some embodiments, the present invention may determine when and if a selection 200 will animate or not. In some embodiments, the composer or sender of the compiled video message 202 may determine whether a selection 200 will animate or not. In some embodiments, the recipient or viewer of the compiled video message 202 may determine whether a selection 200 may animate or not. It is further contemplated that in some embodiments, either a sender, a composer, a recipient, or a viewer, or any combination, may determine whether a selection 200 may animate or not. It is still further contemplated that in some embodiments, either a sender, a composer, a recipient, or a viewer, or any combination, may determine whether a selection 200 may animate or not, and in what manner a selection 200 may or may not animate.

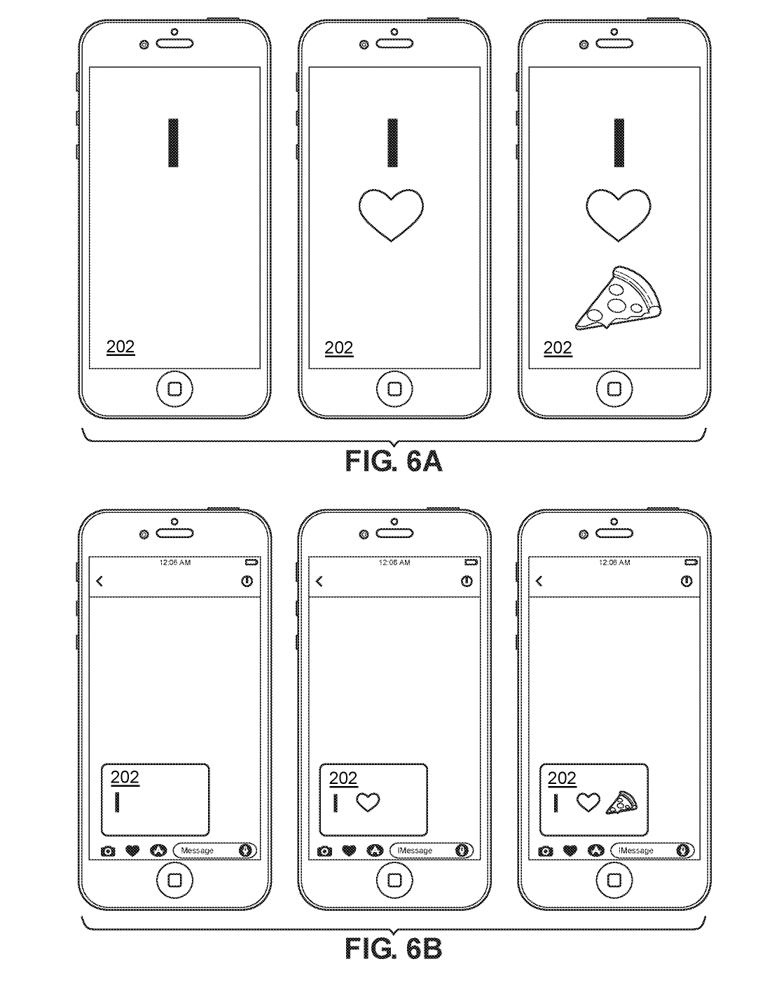

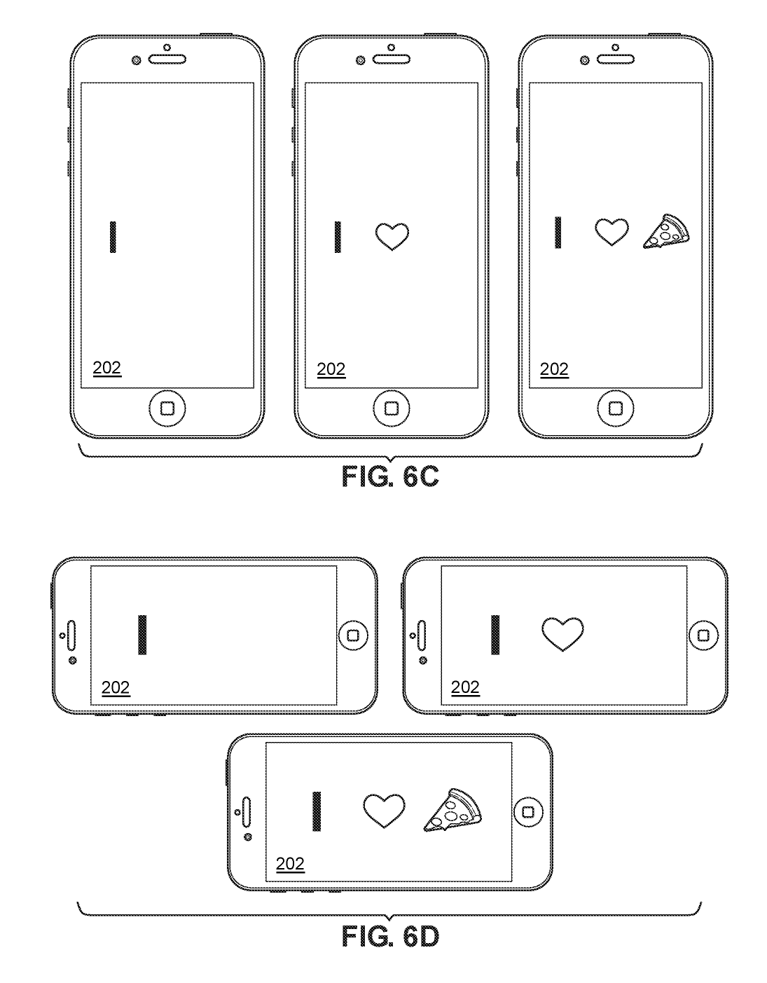

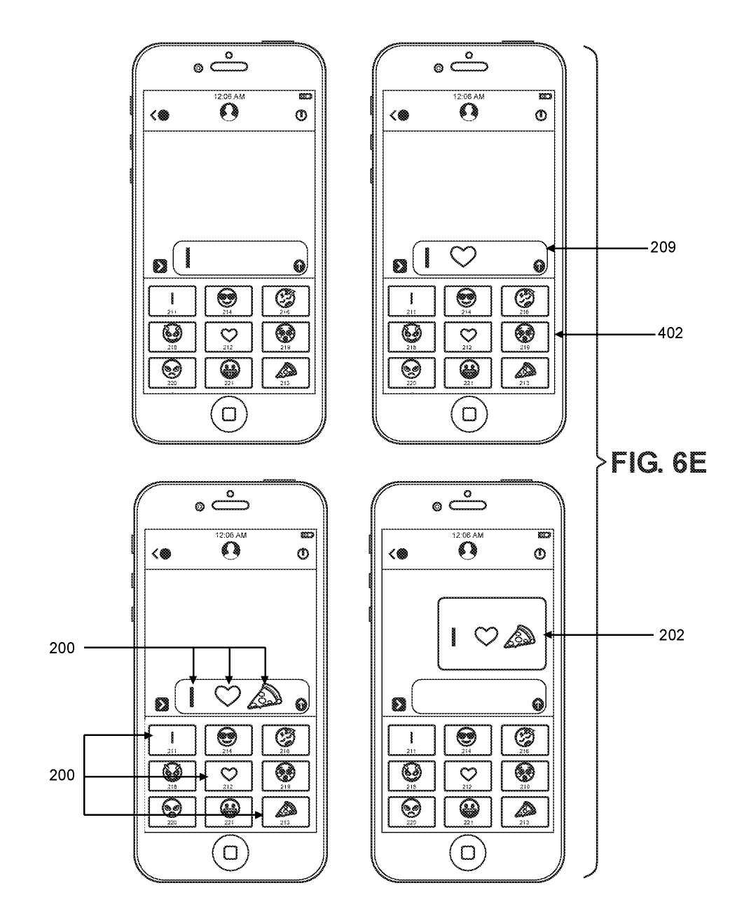

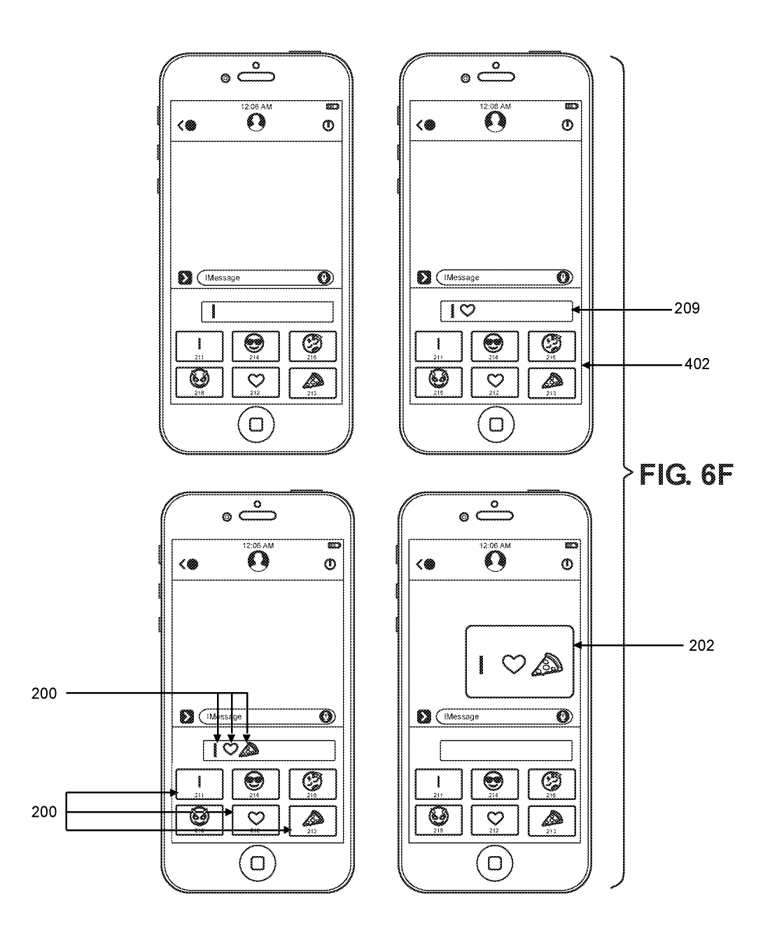

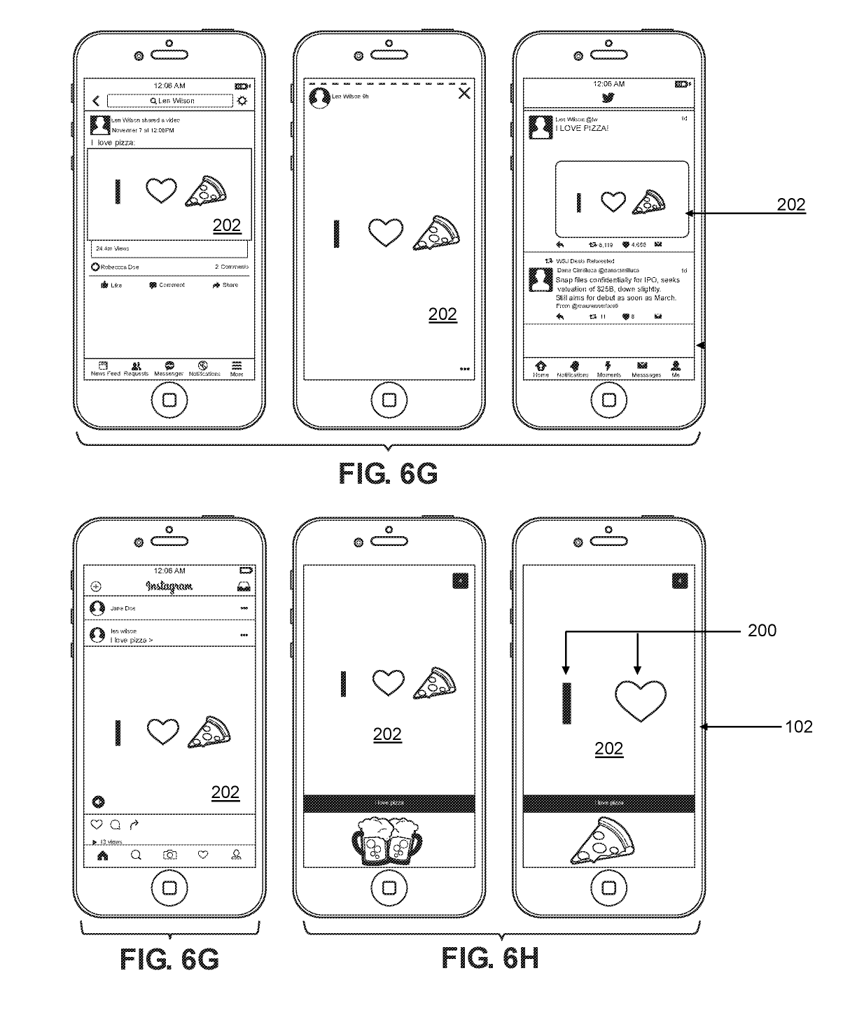

It is contemplated that preview port 209 may support a vertical, diagonal, or other orientation in addition to or in substitution of a horizontal arrangement of selections 200 as depicted in FIG. 2 and FIG. 6A, which shows an example of a compiled video 202 exported from a vertical preview port 209.

It is contemplated that a three-video port embodiment as shown in FIG. 2 at 209 is but one of many potential embodiments. Accordingly, it is contemplated that a preview port such as 209 may facilitate the animation of more than one selection 200. Alternatively, the present invention may provide for more or less than three video animations. It is contemplated that any number or combination of video ports may be incorporated into the present invention as appropriate.

It is also contemplated that playback of the preview port 209 and the compiled video message 202 may take a variety of forms. For example, in one embodiment, it is contemplated that once each selection 200 has animated, the compiled video message 202 playback may cease. To use the illustration provided in FIG. 2, for purposes of illustration and not of limitation, the “I” 211 might animate first, the heart 212 might animate second, and the pizza 213 might animate third, followed by all three selections 200 ceasing to animate. It is also contemplated that in some embodiments, again for purposes of illustration, the first selection 200, here an “I” element 211, could animate until the second selection 200, here a heart 212, begins animating, and then the “I” 211 could cease animating. In this same hypothetical embodiment, once a third selection 200, here a pizza 213, begins animating, the heart 212 could cease animating. It is also contemplated that in some embodiments, the selections 200 may start and stop animating in order, may then reverse their order, and may continue a forward and reverse sequence. For example, using the illustrative and non-limiting example shown in FIG. 2, an “I” 211 could start animating, and then a heart 212 could start animating, and the “I” 211 could stop animating. Then, a pizza 213 could start animating and the heart 212 could stop animating. Then, the pizza 213 could cease animating, and the heart 212 could begin animating again. Then, the “I” 211 could begin animating again and the heart 212 could cease animating. In some embodiments, it is contemplated that this sequence could continue indefinitely. It is also contemplated that any sequence could be facilitated by the present invention, such as by way of illustration and not of limitation, the first selection 200 could animate, followed by the third selection 200, followed by the second selection 200, followed by the third selection 200, followed by the first selection 200. Alternatively, it is also contemplated that any selection 200 may start and stop animating more than once before another selection 200 either begins animating or ceases animating. It is therefore contemplated that the present invention gives the user a great degree of control over the sequence, duration, and manner over the animation or presentation of each selection 200, so as to maximize the user's abilities to communicate one or more expressions. By way of illustration and not of limitation, one example of many potential examples of an animation sequence as generally provided in FIG. 2 could be as follows: the “I” 211 might animate at the initiation of playback, the heart 212 might animate at the one second mark of playback, and the pizza 213 might animate at the two second mark of playback.

Continuing with FIG. 2, in some embodiments it is contemplated that video compiling code 203 may partially or fully be implemented by the present invention within or by preview port 209.

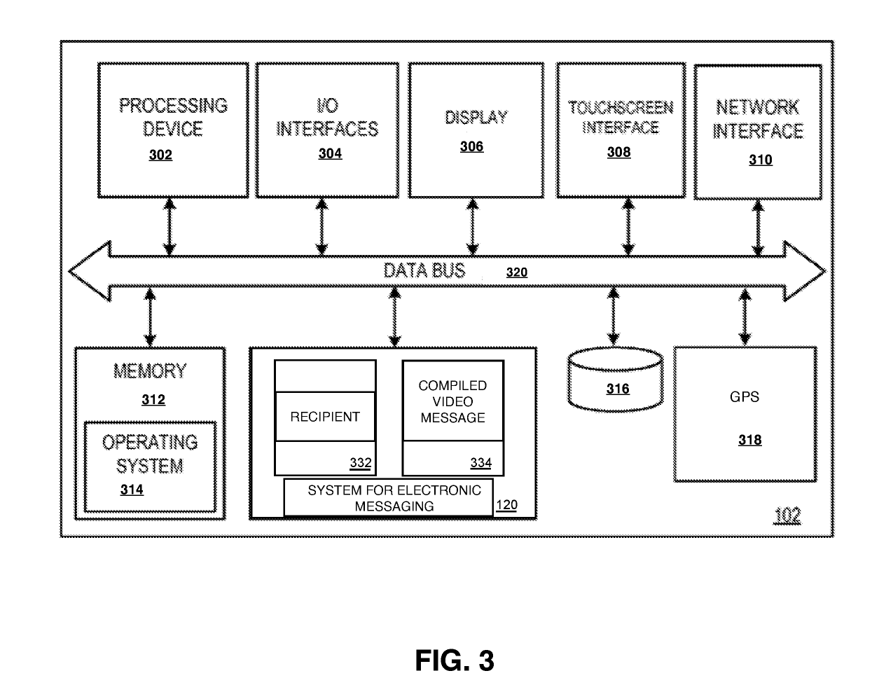

FIG. 3 illustrates mobile electronic device 102 shown in FIG. 1. As described earlier, electronic, or simply mobile, device 102 may be a tablet computer or smartphone but may also be embodied in any one of a wide variety of wired and/or wireless computing devices. As shown in FIG. 3, mobile device 102 includes a processing device (processor) 302, input/output interfaces 304, a display 306, a touchscreen interface 308, which may, in one embodiment, be a physical keyboard, a network interface 310, a memory 312, and operating system 314, a mass storage 316 and an GPS 318, with each communicating across a local data bus 320. Additionally, mobile device 102 incorporates a system for electronic messaging 101, which is depicted as recipient 332 and compiled video message 334 although the location of information 332 and 334 could vary.

The processing device 302 may include any custom made or commercially available processor, a central processing unit (CPU) or an auxiliary processor among several processors associated with the mobile device 102, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 312 can include any one of a combination of volatile memory elements (e.g., random-access memory (RAM, such as DRAM, and SRAM, etc.)) and nonvolatile memory elements. The memory typically comprises native operating system 314, one or more native applications, emulation systems, or emulated applications for any of a variety of operating systems and/or emulated hardware platforms, emulated operating systems, etc. For example, the applications may include application specific software which may comprise some or all the components of the mobile device 102. In accordance with such embodiments, the components are stored in memory and executed by the processing device. Note that although depicted separately in FIG. 3, the system and method for electronic messaging 100 may be resident in memory such as memory 312.

Touchscreen interface 308 is configured to detect contact within the display area of the display 306 and provides such functionality as on-screen buttons, menus, keyboards, etc. that allows users to navigate user interfaces by touch. For some embodiments, the mobile device 102 will comprise GPS 318 or other means to determine the location of the mobile device 102.

One of ordinary skill in the art will appreciate that the operating system 314 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 3, network interface device 310 comprises various components used to transmit and/or receive data over a networked environment such as depicted in FIG. 1. When such components are embodied as an application, the one or more components may be stored on a non-transitory computer-readable medium and executed by the processing device.

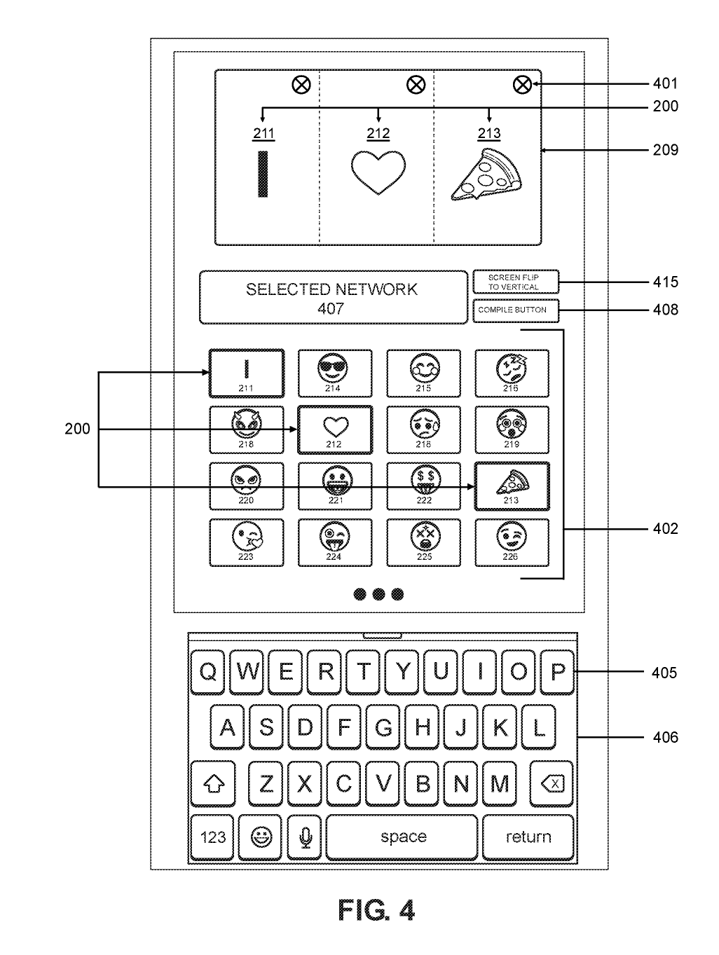

FIG. 4 illustrates an exemplary user interface for a system and method for electronic messaging. In the embodiment depicted, a user may choose one or more selections 200 from a selection bank 402, or one or more letters 405 from a keyboard 406 and arrange one or more of the selections 200 in a preview port 209, and may also remove one or more selections by clicking on “X” remove tab 401. It is contemplated that the present invention may support various means of choosing and arranging selections 200 within the preview port 209 including, by way of illustration and not of limitation, a drag and drop functionality, a functionality wherein a user may click on a selection 200 and the selection may automatically populate within the preview port 209, a voice-activated functionality, or a combination thereof. Positions of keyboard 405, selection bank 402, preview port 209, selections 200, and all other elements provided by the present invention may be rearranged in any manner capable of implementation by the present invention, such as by way of illustration and not of limitation, above or below another element, next to another element, superimposed over another element, hidden behind another element, magnified in relationship to another element, or any other manner.

Once selected and arranged, the selections 200 may be compiled, rendered, or both and posted to the appropriate network 407 by pressing compile button 408. It is contemplated that in some embodiments, the network 407 may select the manner in which selections 200 are compiled, rendered, or both. It is further contemplated that in some embodiments, the present invention may select the manner in which selections 200 are compiled, rendered, or both. It is still further contemplated that in some embodiments, the network 407 and present invention may each partially select the manner in which selections 200 are compiled, rendered, or both. In some embodiments, the present invention may also provide for a screen flip button 415, which may enable a user to compose a compiled video message 202 in a vertical or horizontal layout within preview port 209, then arrange the selections 200 in a vertical or horizontal playback sequence, allowing a user to export a vertical or horizontal compiled video message 202. It is contemplated that the present invention may provide for a user to determine the manner in which the compiled video message 202 is compiled, rendered, or both.

Continuing with FIG. 4, it is contemplated that preview port 209 may also or alternatively support an alternative or additional arrangement of selections 200, such as by way of illustration but not limitation, a horizontal, diagonal, circular, square, or other orientation or shape of selections 200 within preview port 209.

Continuing with FIG. 4, in some embodiments, it is contemplated that the present invention may provide for video compiling code 203 to be implemented by preview port 209. In some embodiments, it is contemplated that video compiling code 203 may be implemented by the system and method upon a user's action of selecting compile button 408. In some embodiments, it is contemplated that video compiling code 203 may be partially implemented by or within preview port 209 and partially implemented by the system and method upon a user's action of selecting compile button 408. Furthermore, in some embodiments, it is contemplated that video compiling code 203 may be partially implemented by or within preview port 209 once a user chooses a selection 200 from selection bank 402.

Continuing with FIG. 4, in some embodiments, it is contemplated that the present invention may provide for a playback delay code to be implemented by or within preview port 209. In some embodiments, it is contemplated that a playback delay code may be implemented by the system and method upon a user's action of selecting compile button 408. In some embodiments, it is contemplated that a playback delay code may be partially implemented by or within preview port 209 and partially implemented by the system and method upon a user's action of selecting compile button 408. In some embodiments, it is contemplated that a playback delay code may be partially implemented by or within preview port 209 once a user chooses a selection 200 from selection bank 402.

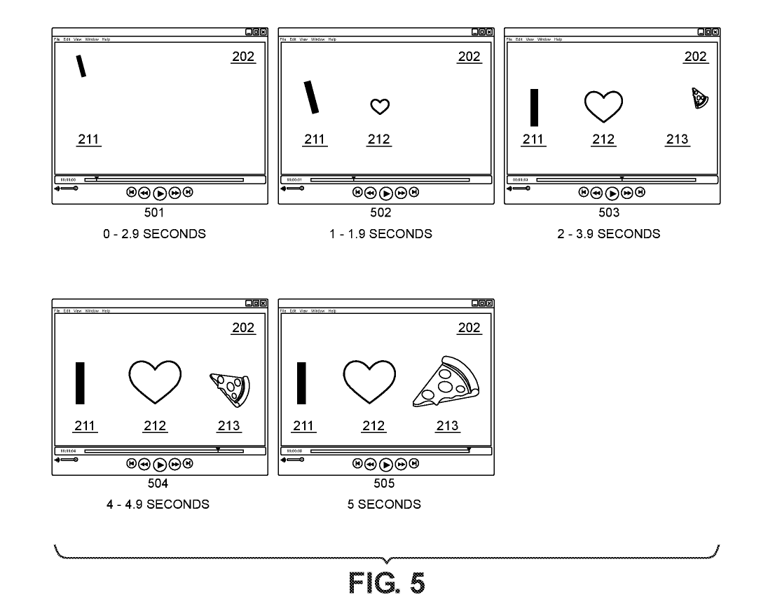

FIG. 5 illustrates a playback sequence of a compiled video message 202 in accordance with one embodiment of the present invention. In the embodiment depicted, the first portion of a sequence 501 begins playback of an animation of a bouncing “I” 211 at the 0-0.9 second mark, the second portion of a sequence 502 continues playback of the “I” animation and begins playback of an animation of a pulsing heart 212 at the 1-1.9 second mark, the third portion of a sequence 503 continues playback of the pulsing heart animation and begins playback of a spinning slice of pizza 213 at the 2-3.9 second mark, and the fourth portion of a sequence 504 continues playback of all three selections 200 (the bouncing “I” 211, the pulsing heart 212, and the spinning slice of pizza 213) at the 4-4.9 second mark. It is contemplated that at the 5 second mark 505, all animations of selections 200 are complete and either the playback may stop or may loop. In one embodiment of the present invention, once a selection 200 such as a bouncing “I” animation 211, a pulsing heart 212, or a spinning slice of pizza 213 begins to animate, it may animate for a set period of time and may then cease animating. By way of example and not of limitation, in the example illustrated in FIG. 5, the bouncing “I” 211 may begin animating at the beginning of playback and may cease its animation at the 3.0 second mark of playback, the pulsing heart 212 may begin to animate at the 1.0 second mark of playback and may cease its animation at the 4.0 second mark of playback, and the spinning slice of pizza 213 may begin to animate at the 2.0 second mark and may cease its animation at the 5.0 second mark. In this illustrative example, therefore, each selection may have animated for three seconds.

In some embodiments, it is contemplated that selections 200 may continuously animate throughout playback. Alternatively, in another embodiment, one or more selections 200 may animate for a period of time, then may cease animating. Alternatively, in another embodiment, one or more selections 200 may start and stop animating repeatedly throughout playback.

Continuing with FIG. 5, those of skill in the art will appreciate that the present invention may alternatively provide for longer or shorter delays between selections. It is also contemplated that playback may comprise one or more stationary and non-animated selections 200. It is further contemplated that one or more selections 200 may start and stop animating, rather than animating continuously.

It is further still contemplated that the sequence depicted in FIG. 5 may reverse itself. For example, once the third animation 503 begins, the second animation 502 may cease, followed by the first animation 501 ceasing its animation. In one or more embodiments, it is contemplated that this “forward” and “reverse” sequencing of selections may repeat until a user causes it to cease.

Continuing with FIG. 5, in an alternative embodiment, only one selection 200 may animate. In yet another embodiment, some but not all selections 200 may animate. In an alternative embodiment, one or more selections 200 may disappear. In another alternative embodiment, one or more selections 200 may disappear and reappear.

In another contemplated embodiment, the playback sequence illustrated in FIG. 5 could proceed vertically, that is, in a top-down visual orientation.

FIG. 6A-H illustrate a plurality of exemplary user interfaces for a system and method for electronic messaging. FIG. 6A-H also illustrates a plurality of compiled video 202 examples displayed in messaging apps, social media, and native video players. It should be noted that how the user interface and compiled video 202 examples are displayed and viewed are not limited to these examples. FIG. 6A illustrates a vertical arrangement of the present invention created by a vertical variation of the preview port 209, wherein a compiled video message 202 that contains one or more selections 200 progresses from top to bottom of a user's screen. FIG. 6B illustrates a horizontal arrangement of the present invention, wherein a compiled video message 202 that contains one or more selections 200 progresses from left to right in a bounded portion of a user's screen in a messaging application. FIG. 6C illustrates a horizontal arrangement of the present invention, wherein a compiled video message 202 that contains one or more selections 200 progresses from left to right of a user's screen. FIG. 6D illustrates a horizontal arrangement of the present invention, wherein a compiled video message 202 that contains one or more selections 200 progresses from left to right of a user's screen when the user's device is oriented in landscape mode. FIG. 6E illustrates a selection process according to the present invention, wherein a user may compose a compiled video message 202 that contains one or more selections 200 that may be chosen from a selection bank 402, and arranged in an order within a preview port 209, and sent via a messaging application or social media network. FIG. 6F illustrates a selection process according to the present invention, wherein a user may choose one or more small-sized selections 200 from a selection bank 402, arrange them in an order within a preview port 209, and send a compiled video message 202 via a messaging application or social media network. FIG. 6G illustrates a sequence according to the present invention wherein a user may post a compiled video message 202 to a social media platform. FIG. 611 illustrates one or more embodiments of the present invention wherein the selections 200 within a compiled video message 202 may be written in words below or otherwise on the same screen as the compiled video message 202. FIG. 611 also shows two of many possible arrangements wherein the selections 200 may be either displayed in a row or separated into two different parts of a user's electronic device 102.

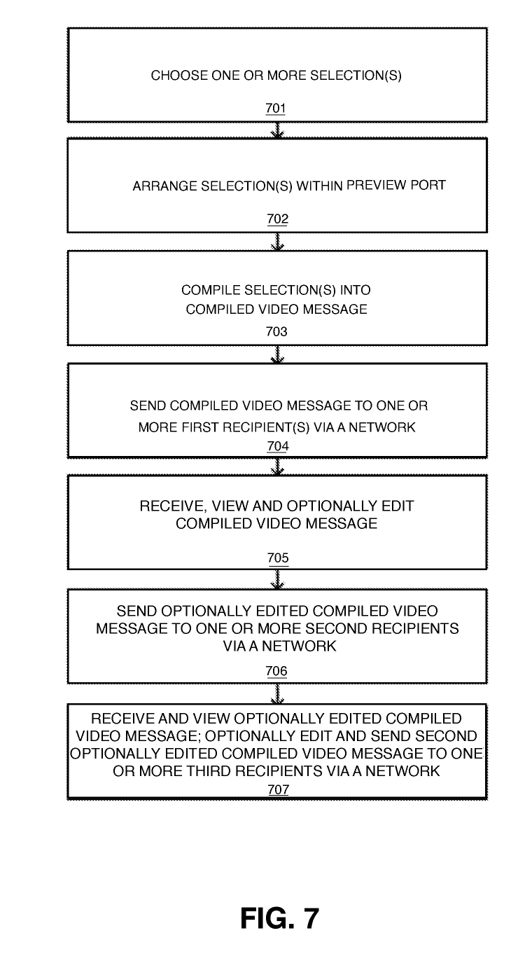

FIG. 7 is a flowchart depicting an exemplary embodiment of a system and method for electronic messaging that may be performed by mobile device 102, 104, or 106 of FIG. 1. As shown in FIG. 7, the method includes the steps of: choosing one or more selection(s) 701; arranging the selection(s) within a preview port 702; compiling the selection(s) into a compiled video message 703; sending the compiled video message to one or more first recipients via a network 704; receiving, viewing, and optionally editing the compiled video message 705; sending the optionally edited compiled video message to one or more second recipients via a network 706; receiving and viewing the optionally edited compiled video message by the second recipient(s), and then optionally editing the optionally edited compiled video message into a second compiled video message, and optionally sending the second optionally edited compiled video message to one or more third recipient(s) via a network 707.

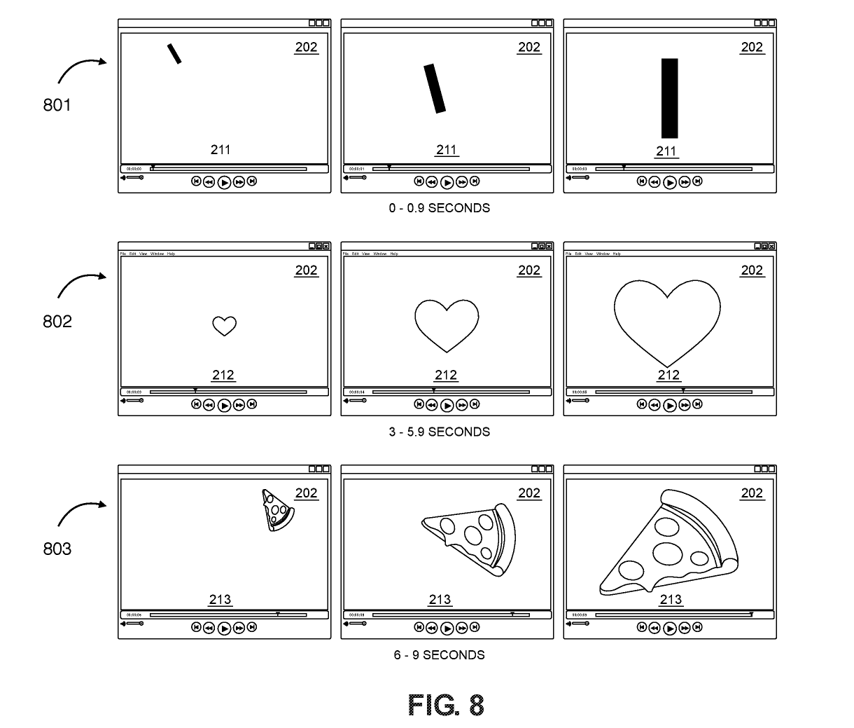

FIG. 8 illustrates a playback sequence of a compiled video message 202 in accordance with one embodiment of the present invention. In the embodiment depicted, the first portion 801 plays a selection 200, here depicted for illustration purposes only as a bouncing “I” 211, for the first 0 to 2.9 seconds of playback then disappears. Second portion 802 plays a selection 200, here depicted for illustration purposes only as a pulsing heart 212, for the next 3 to 5.9 seconds of playback and disappears. The third portion 803 plays a selection 200, here depicted for illustration purposes only as a spinning slice of pizza 213, for the final 6 to 9 seconds of playback, and remains as a still image.

Continuing with FIG. 8, in some embodiments, one or more selections 200 may start and stop playback throughout the playback of compiled video message 202. Alternatively, in other embodiments, the final portion may continue playback in a loop. In some embodiments, while the first selection 200 is still playing, another selection 200 could appear and begin its playback.

Continuing with FIG. 8, in some embodiments it is contemplated that the present invention may provide that selections 200 may scale larger or smaller. In some embodiments it is contemplated that a scaling functionality may be a feature controlled by a user. In some embodiments, it is contemplated that a scaling functionality may be controlled by the present invention, or by the constraints of either a network, an electronic device, or media platform.

In order to facilitate the aforementioned functionality, various aspects may be performed by one or more of the mobile devices 102, 104, and 106. In one embodiment, the mobile devices are operative to perform, at least in part, the method depicted in the flowchart of FIG. 3 and described above.

If embodied in software, it should be noted that each block depicted in the accompanying flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the electronic device 102, 104, or 106. The machine code may be converted from the source code, etc. If embodied in hardware, each block may represent a circuit or a number of interconnected circuits to implement the specified logical function(s).

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### Conclusions, Ramifications, and Scope

While certain embodiments of the invention have been illustrated and described, various modifications are contemplated and can be made without departing from the spirit and scope of the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the present invention with which that terminology is associated. In general, the terms used in the following claims should not be constructed to limit the present invention to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the present invention is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the present invention.

What is claimed is:

1. A method of electronic messaging, comprising:
selecting, by a first electronic device, a first selection and a second selection;
arranging and sequencing, by a first electronic device, the first selection and the second selection into a sequence;
compiling, by a first electronic device, the sequence into a compiled video message;
sending, by a network, the compiled video message to a second electronic device;
receiving, by the second electronic device, the compiled video message; and
displaying and initiating playback, by the second electronic device, of the compiled video message.

2. The method of claim 1, wherein the first selection, and the second selection are video animations.

3. The method of claim 2, wherein the playback proceeds in an order:
the first selection begins animating and continues animating, then,
the second selection begins animating and continues animating.

4. The method of claim 2, wherein only one selection animates at a time.

5. The method of claim 2, further comprising the steps of:
performing, by second electronic device, at least one edit to the compiled video message;
compiling, by the second electronic device, the edit and the compiled video message into an edited compiled video message;
sending, by a network, the edited compiled video message to a third electronic device;
receiving, by the third electronic device, the edited compiled video message; and
displaying and initiating playback, by the third electronic device, of the edited compiled video message.

6. A system for electronic messaging, comprising:
an electronic device operative to:
provide a selection bank;
facilitate a choice by a first user of a first selection from the selection bank; and
facilitate a choice by the first user of a second selection from the selection bank;
facilitate an arrangement by the first user of the first selection and the second selection into a selection sequence;
compile the selection sequence into a compiled video message;
send the compiled video message to a second user; and
displaying and initiate playback of the compiled video message for the second user.

7. The system of claim 6, further comprising an electronic device operative to animate and maintain the animation of the first selection, animate and maintain the animation of the second selection, and animate and maintain the animation of the third selection in sequential order.

8. The system of claim 6, further comprising an electronic device operative to animate only one of the first selection or the second selection.

9. The system of either claim 6, further comprising an electronic device operative to:
facilitate the second user to make at least one edit to the compiled video message;
compile the edit and the compiled video message into an edited compiled video message;
send the edited compiled video message to a third user; and
initiate playback of the edited compiled video message for the third user.

10. A non-transitory, tangible computer-readable medium having stored thereon computer-executable instructions, which, when executed by a computer processor, enable performance of the method comprising:
selecting, by a first electronic device, a first selection and a second selection;
arranging and sequencing, by a first electronic device, the first selection and second selection;
compiling, by a first electronic device, the sequence into a compiled video message;
sending, by a network, the compiled video message to a second electronic device;
receiving, by the second electronic device, the compiled video message; and
displaying and initiating playback, by the second electronic device, of the compiled video message.
